(19) United States
(12) Patent Application Publication
(10) Pub. No.: US 2003/0058836 A1
(43) Pub. Date: Mar. 27, 2003

(54) Method for establishing a multimedia connection with quality of service using an ATM backbone

(76) Inventor: Roni Even, Tel-Aviv (IL)

Correspondence Address: CARR & FERRELL LLP, 2225 EAST BAYSHORE ROAD, SUITE 200, PALO ALTO, CA, 94303, US

(21) Appl. No.: 09/784,586

(22) Filed: Feb. 15, 2001

Related U.S. Application Data
(60) Provisional application No. 60/186,013, filed on Mar. 1, 2000.

(51) Int. Cl. H04L 12/66; H04L 12/28; H04L 12/56

(52) U.S. Cl. 370/352; 370/395.43

(57) ABSTRACT

A method for establishing a multimedia connection with quality of service (QoS) using an ATM backbone for ISDN network or IP network calls. QoS makes IP over ATM useful for video and audio conferencing by ensuring a minimum packet error rate at acceptable bit transmission rates. The invention will utilize the H.323 annex C protocol to transmit IP gateway transmissions through an ATM backbone network. This invention enables H.320 endpoints having a connection to an ATM network to send QoS communications to other endpoints. When call setup is initiated between two endpoints, an ISDN (or IP) call is sent to a gateway. The gateway will utilize a network gatekeeper to route the call to the addressed endpoint's corresponding gateway. When a route is established, the call will be converted to an H.323 annex C protocol transmission and sent through the ATM backbone to the destination gateway. At the destination gateway, the call will be converted to another protocol (as necessary) for delivery to the destination endpoint.

### TECHNICAL FIELD

This application claims priority from Provisional Application No. 60/186,013.

This invention relates to the field of multimedia communication and, more particularly, relates to improving Quality of Service over an ATM network or ATM backbone.

### BACKGROUND

Asynchronous transfer mode (“ATM”) is a cell-oriented switching and multiplexing technology well suited for the advanced communication needs of the present day. Modem communication systems require the accommodation of multimedia (real time video and audio) communications. Video and audio transmissions are continuous data streams that will lose quality if packets are delayed or lost on a packet-based network. A challenge for modern communication system designers is to enable reliable multimedia capabilities using popular transport methods.

Video conferencing terminals are using different physical transports like ISDN, IP and ATM. These different data transports are packet-based or constant bit rate based and run different multimedia conferencing protocols like, but not limited to, SIP, H.320 and H.323. ATM technology has the capacity to carry multimedia communications on a single network infrastructure. Currently, there is no standard definition as to how to build a multimedia system that includes varying combinations of H.320 and H.323 based end points that are connected via an ATM backbone.

When building an ATM-based video conferencing system solution that includes terminals and multi-point control units (“MCU”), the infrastructure typically includes an ATM backbone and access gateways. A gateway, generally, is an interface between two networks having different protocols. The gateways connect Ethernet-based LANs, ISDN PRI and BRI lines to the ATM backbone. When a multimedia communication such as a call is initiated from an ISDN (H.320) based terminal through the ATM to a LAN based terminal, the call will be transmitted via an IP over ATM based data transport. On such a transport, there is no guarantee that packets will travel end to end at constant bit rate.

Current ATM backbones make it difficult to enable endpoints having IP (H.323) terminals connected to a gateway to transmit quality of service (“QoS”) communications to other endpoints. ATM networks regularly simulate IP transmissions by setting a circuit and implementing IP over it, but such connections are not suitable for video transmissions that require maximized transmission rates and minimized error rates. Therefore, current IP over ATM efforts that usually employ ordinary “best effort” protocols make high-bandwidth video transmissions difficult to achieve.

One prior art technique is to use an access router connected to a gateway and providing an interface to an ATM network. Typically, an IP or Ethernet connection exists between the gateway and the access router. The access router then provides an IP connection over the ATM network.

Another prior art technique is to have an access router that specifically handles H.323 endpoints. In this scenario, a terminal connects to the H.323 access router to provide standard H.323 connections.

Similarly, an H.323 compatible terminal can connect directly to an ATM network.

The current ITU standard H.323 annex C is an optional enhancement allowing H.323 endpoints to establish QoS-based media streams on ATM networks using ATM Adaptation Layer type 5 (AAL5). Implementation of this enhancement permits a more reliable exchange of information between endpoints in compliance with differing standards. More information regarding the H.323 standard and annex C can be found by visiting the ITU Internet website of www.itu.org or Internet Engineering Task Force website of www.ietf.org.

It should be noted that in the prior art, there is no definition of standards to interface an H.320 endpoint, or for that matter, non-H323 endpoints to an ATM network through a gateway using the H.323 annex C protocol. An article published by the ATM Forum, “Gateway for H.323 Media transport Over ATM”, document number STR-SAA-RMOA-01.00, describes a gateway that provides a QoS communication over an ATM network for H.323 endpoints. Again, the prior art omits any standard, proposal, or definition for a method to deliver QoS for non-H.323 endpoints.

Therefore, it is clear that there is a need in the art for a system and a method for establishing a multimedia connection with quality of service using an ATM backbone for endpoints connected to a gateway.

### SUMMARY

The present invention overcomes the above-described problems in the prior art by providing a method for establishing a multimedia connection with quality of service using an ATM backbone. Generally described, the present invention provides a unique manner of using the H.323 annex C protocol to establish ATM gateway connections between H.320 terminals or between H.320 terminals and H.323 terminals. The invention is usefull for setting up guaranteed QoS for IP communications, making video and other multimedia transmissions more reliable and within minimum error rates and maximum transmission rates.

Generally described, the present invention establishes a first ISDN connection between an H.320 endpoint and the Gateway. The invention then establishes a second connection with an ATM backbone network that connects the two Gateways, either by utilizing a physical or virtual circuit and from the second Gateway to the second endpoint. This second connection will setup a recognized QoS connection between the two endpoints in accordance with H.323 annex C protocol. The ISDN connection will then be converted at the first gateway to an H.323 annex C protocol transmission and be transmitted using AAL5 to the gateway corresponding to the second endpoint. The transmission will be converted at the second gateway and be transmitted to the second endpoint.

Objects, features and advantages of the present invention will become apparent upon reading the following detailed description of the preferred embodiments of the invention, when taken in conjunction with the accompanying drawings and the appended claims.

### BRIEF DESCRIPTION OF THE DRAWINGS

FIG. 1 is a block diagram illustrating a typical system architecture of a video and/or audio conferencing system.

FIG. 2 is a block diagram illustrating an exemplary embodiment of the present invention.

FIG. 3 is a flow diagram illustrating the steps involved in an exemplary embodiment of the present invention.

### DETAILED DESCRIPTION OF THE INVENTION

Turning now to the figures in which like numerals represent like elements throughout the several views, several exemplary embodiments of the present invention are described. However, first a few terms are defined.

QoS—Quality of Service. On the Internet and in other networks, Quality of Service (QoS) is the idea that transmission rates, error rates, and other characteristics can be measured, improved, and, to some extent, guaranteed in advance. QoS is of particular concern for the continuous transmission of high bandwidth video and multimedia information. Transmitting this kind of content dependably is difficult in public networks using ordinary “best effort” protocols.

ATM—Asynchronous Transfer Mode. ATM is one of the general classes of packet technologies that communicate multimedia information via an address contained within the packet.

AAL5—ATM Adaptation Layer type 5. The AAL divides user information into segments suitable for packaging in a series of cells for transmission. Type 5 is a simple and efficient adaptation layer.

ISDN—Integrated Services Digital Network. Integrated Services Digital Network (ISDN) is a set of ITU standards for digital transmission over ordinary telephone copper wire as well as over other media.

BRI/PRI—In the Integrated Services Digital Network (ISDN), there are two levels of service: the Basic Rate Interface (BRI), intended for the home and small enterprise, and the Primary Rate Interface (PRI) for larger users. Both rates include a number of B (Bearer) channels and a D (Delta) channel. The B channels carry data, voice, and other services. The D channel carries control and signaling information. In U.S. systems, BRI includes two B channels and a D channel. PRI includes 23 B channels and one D channel.

ITU-T—International Telecommunication Union—Telecommunication Standardization Sector. It is the primary international body for fostering cooperative standards for telecommunications equipment and systems. It is located in Geneva, Switzerland.

H.323—ITU-T Recommendation H.323—Packet-based multimedia communications systems, including Internet Protocol networks.

H.320—ITU-T Recommendation H.320—Narrow-band visual telephone systems and terminal equipment. Allows conferencing over a switchboard, including ISDN communications.

Endpoint—A physical location or apparatus which can generate and/or terminate information streams.

Terminal—An H.323 Terminal is an endpoint on the network which provides for real-time, two-way communications with another H.323 terminal, gateway, or Multi-point Control Unit. This communication may include control indications, audio, moving color video pictures, and/or data between the two terminals. A terminal may provide speech only, speech and data, speech and video, or speech, data and video. The terminal may be also an H.320 based terminal.

Gatekeeper—The Gatekeeper (GK) is an H.323 entity on the network that provides address translation and controls access to the network for H.323 terminals, Gateways and MCUs. The Gatekeeper may also provide other services to the terminals, Gateways and MCUs such as bandwidth management and locating Gateways. In the case of SIP, the address translation functionality is done by an SIP proxy or an SIP location server.

Gateway—An H.323 Gateway (GW) is an endpoint on the network, which provides for real-time, two-way communications between H.323 Terminals on the packet-based network and other Terminals on a switched circuit network, or to another H.323 Gateway. Other Terminals include those complying with Recommendations H.310 (H.320 on B-ISDN), H.320 (ISDN), H.321 (ATM), H.322 (GQOS-LAN), H.324 (GSTN), H.324M (Mobile), and V.70 (DSVD) or SIP.

Multi-point Control Unit (MCU)—The Multi-point Control Unit (MCU) is an endpoint on the network which provides the capability for three or more terminals to participate in a multiunit (multimedia) conference.

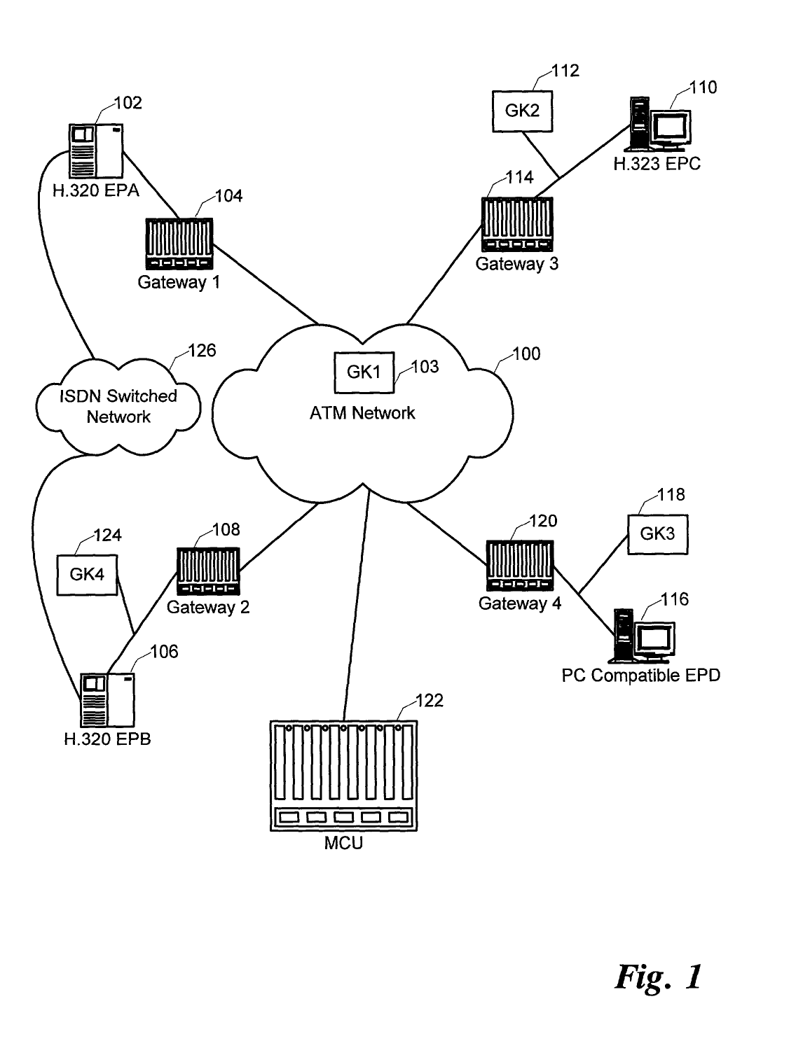

FIG. 1 is a system diagram illustrating an exemplary system architecture suitable for embodying the present invention. The ATM network 100 is the backbone of the solution. Using an ATM network 100, a connection line can provide many services. One such service is to simulate an IP connection by setting up an ATM circuit and implementing IP over it. However, this technique does not guarantee a QoS connection. The present invention uses an IP connection, or a simulated IP connection for the setup and control of a video conference. Then, a separate ATM connection is opened for the delivery of video between two endpoints. For each of these ATM connections, the QoS can be defined. The ATM network 100 supports both virtual circuit creation and multiple end points over AAL5. FIG. 1 shows a local site EPA (End Point “A”) 102 connected to the ATM network 100 via Gateway 1 104 and Terminal EPB 106 connected to the ATM network 100 via Gateway 2 108. In this example, both terminals are operating under the H.320 protocol (“H.320 terminals”). These terminals can be part of an ISDN network 126 outside of the ATM infrastructure. Terminal EPA 102 is connected via Gateway 104 to the ATM networks 100. Gatekeeper GK1 103 is part of the ATM network 100 infrastructure. Terminal EPB 106 is connected via Gateway 108 to the ATM networks 100. Terminal EPC 110 has Gatekeeper GK2 112 in its zone and is using Gateway 3 114 to connect to the ATM network 100. PC compatible Terminal EPD 116 has Gatekeeper GK3 118 in its zone and is using Gateway 4 120 to connect to the ATM network 100. The MCU 122 is connected directly to the ATM network 100.

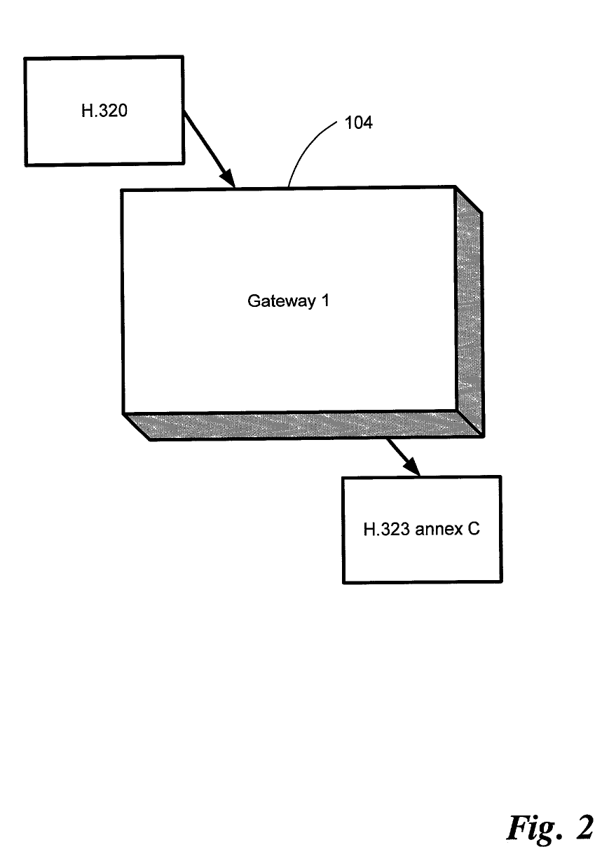

FIG. 2 illustrates that Gateway 1 104 functions to translate protocol from H.320 to H.323 annex C. The system enables point to point calls from H.320 terminals to H.320 or H.323 terminals using the H.323 annex C protocol on the ATM network 100. Additionally, the system enables multi-point conferences on the MCU 122 with H.320 and H.323 participants while using H.323 annex C protocol on the ATM network 100. The MCU supports H.323 annex C while the H.320 and H.323 terminals use their respective gateways to translate from their native protocols to the H.323 annex C protocol.

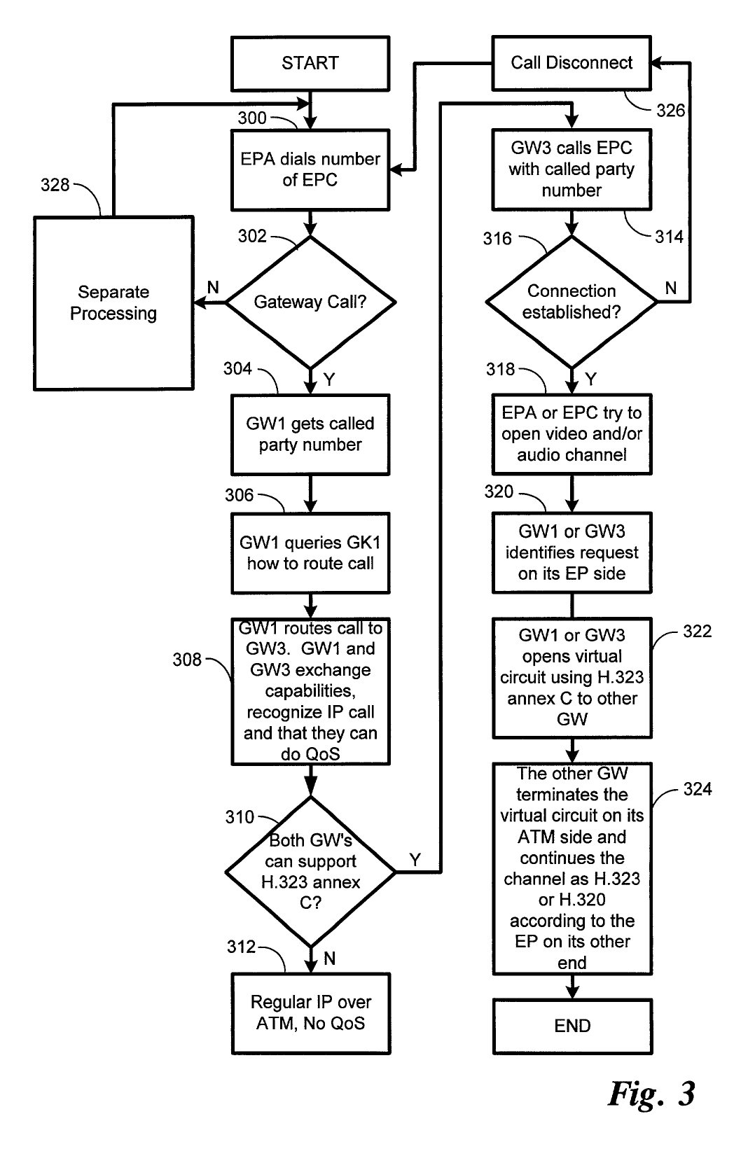

FIG. 3 is a flow diagram illustrating exemplary steps involved in an exemplary call setup between H.320 and H.323 terminals. The same sequence may apply to H.320 calls.

The general concept is that the system is configured such that, during a call setup between endpoints that goes through an ATM network 100, the gateways that reside between the endpoints and the ATM network 100 can support H.323 annex C protocol for QoS IP over ATM calls. The call will establish the ATM network component of the call according to H.323 annex C. The component of the call between the ATM network 100 and the respective endpoints (via their respective gateways) can be H.320 for calls originating from ISDN networks or H.323 for calls originating from IP networks.

Initially, EPA 102 initiates a call to EPC 110 300. If the call is not via gateway 104, separate processing outside of the ATM network 328 will be needed. If the call is a gateway call 302, then Gateway 1 104 gets the called party number 304. Gateway 1 104 then queries the gatekeeper 1 103 (“GK 1”) concerning how to route the call to the called party 306. All gateways connected to gatekeeper 1 103 are on the same IP network. The gateways register with gatekeeper 1 103 to supply routing information. Gatekeeper 1 103 routes the call to Gateway 3 114. At this point, Gateway 1 104 and Gateway 3 114 exchange capabilities 308. If both of the gateways do not support H.323 annex C 310, the call will be processed as a regular H.323 call 312. The gateways will recognize H.323 annex C is possible for an H.320 (or H.323) network call. If both of the gateways support H.323 annex C, the Gateway 3 114 will call EPC 110 using the called party number 314. If no connection is established 316, then the call is disconnected 326 and the EPA will dial the number of EPC again 300. If a connection is established 316, either EPA 102 or EPC 110 attempts to open a channel for video and/or audio 318. This is accomplished by using an H.245 “open logic channel” command. Either Gateway 1 104 or Gateway 3 114 identifies the request by its respective endpoint 320. The appropriate gateway opens a virtual circuit with QoS according to H.323 annex C procedure to the other gateway 322. The other gateway terminates the virtual circuit on its ATM side and continues the channel as H.323 or H.320 according to the endpoint on its other end 324.

Advantageously, the present invention utilizes H.323 annex C to establish connections with QoS between terminals that are using protocols which do not support QoS, like but not limited to: H.320, H.321, SIP and H.323 without annex C. Said communication can be also with one or more H.323 annex C terminals.

The present invention has been described in relation to particular embodiments, which are intended in all respects to be illustrative rather than restrictive. Those skilled in the art will understand that the principles of the present invention may be applied to, and embodied in, various program modules for execution on differing types of computers and/or equipment, operating in differing types of networks, regardless of the application.

Alternate embodiments will become apparent to those skilled in the art to which the present invention pertains without departing from its spirit and scope. Accordingly, the scope of the present invention is described by the appended claims and supported by the foregoing description.

What is claimed is:

1. A system for establishing a multimedia connection with Quality of Service between two endpoints, wherein at least one of the endpoints is not supporting H.323, the system comprising:
a first endpoint;
a first gateway operative to convert a communication from said first endpoint to an H.323 communication;
a second endpoint;
a second gateway operative to convert an H.323 communication into a communication protocol deliverable to said second endpoint; and
an ATM backbone operative to send an H.323 communication from said first gateway to said second gateway.

2. The system of claim 1, wherein at least one of said first endpoint and said second endpoint support H.320 communications.

3. The system of claim 1, wherein at least one of said first endpoint and said second endpoint support H.321 communications.

4. The system of claim 1, where in at least one of said first endpoint and said second endpoint support SIP communications.

5. The system of claim 1, where in at least one of said first endpoint and said second endpoint support a protocol selected from a group consisting of H.320, H.321 and SIP communication protocols.

6. A gateway for facilitating video communication between two endpoints, wherein at least one of the endpoints is not supporting H.323, the gateway comprising:
a first interface to a first endpoint which is not supporting QoS;
a second interface to an ATM backbone;
a second endpoint connected to said ATM backbone;
the gateway being operable to:
receive a call from said first endpoint over said first interface; and
set up a QoS connection to said second endpoint connected to said ATM backbone, said QoS connection being performed in accordance with H.323 annex C communication protocol.

7. The gateway of claim 6, wherein said first endpoint supports H.320 communications.

8. The gateway of claim 6, wherein said first endpoint supports H.321 communications.

9. The gateway of claim 6, wherein said first endpoint supports SIP communications.

10. The gateway of claim 6, wherein said first endpoint supports a protocol selected from a group consisting of H.320, H.321, and SIP communication protocols.

11. A method for establishing a multimedia connection with Quality of Service via an ATM backbone between a first and second gateway, comprising the steps of:
sending a first Multimedia communication protocol from a first endpoint to a second endpoint to setup a multimedia communication;
if the first Multimedia communication protocol is a gateway call, sending an Initial communication protocol from the first gateway to the ATM backbone for network control functions;
exchanging network capabilities between the first gateway and the second gateway;
converting the Multimedia communication protocol into an H.323 annex C protocol communication at the first gateway;
sending the H.323 annex C protocol communication from the first gateway through the ATM backbone to the second gateway;
converting the H.323 annex C communication into a Multimedia communication protocol at the second gateway; and
delivering the Multimedia communication to the second endpoint; wherein at least either the first endpoint or the second endpoint does not support H.323.

12. A method for establishing a multimedia connection with Quality of Service via an ATM backbone between a first and second gateway, comprising the steps of:
sending a first ISDN protocol communication from a first endpoint to a second endpoint to setup a multimedia communication;
if the first ISDN protocol communication is a gateway call, sending an Initial communication protocol from the first gateway to the ATM backbone for network control functions;
exchanging network capabilities between the first gateway and the second gateway;
converting an ISDN protocol communication into an H.323 annex C protocol communication at the first gateway;
sending the H.323 annex C protocol communication from the first gateway through the ATM backbone to the second gateway;
converting the H.323 annex C communication into an ISDN protocol communication at the second gateway; and
delivering the ISDN protocol communication to the second endpoint.
